(19) United States
(12) Patent Application Publication
(10) Pub. No.: US 2022/0076221 A1
(43) Pub. Date: Mar. 10, 2022

(54) EVENT PARTICIPATION AND MEMORABILIA

(71) Applicant: Fanticipate, Inc., Monument, CO (US)

(72) Inventors: James R. Chiapetta, Delano, MN (US); Edward Blach, Monument, CO (US); Alexander R. Huff, Wayzata, MN (US)

(21) Appl. No.: 17/470,918

(22) Filed: Sep. 9, 2021

Related U.S. Application Data
(60) Provisional application No. 63/076,316, filed on Sep. 9, 2020.

(51) Int. Cl. G06Q 20/12; G06Q 30/06

(52) U.S. Cl. CPC G06Q 20/123; G06Q 2220/12; G06Q 2220/165; G06Q 30/0601

(57) ABSTRACT

Methods for creating a collectible item or items, collectible items, and methods and systems for sale, use and distribution thereof. In some examples, a unique collectible item (or set of items) is created relative to an event such as a sporting event by tracking elements of a participant's performance such as with a wearable device, which stores event data related to the participant. The stored event data is then packaged with or without additional data, such as highlights, interviews, images, etc. and provided to a buyer. In some examples, the buyer will have purchased the right to receive the collectible item in advance of the event. The collectible item may be a tangible object, an intangible data file, or a combination of tangible item and data file.

### CROSS REFERENCE TO RELATED APPLICATIONS

The present application claims the benefit of and priority to U.S. Prov. Pat. App. No. 63/076,316, filed Sep. 9, 2020, and titled EVENT PARTICIPATION AND MEMORABILIA, the disclosure of which is incorporated herein by reference.

### BACKGROUND

Sports collectibles and memorabilia are gathered and traded in various marketplaces including auctions. Select products associated with an event, or a participant in an event, can be of great interest. Buying such products after an event is completed can be cost prohibitive to interested persons. In addition, authentication of such products poses a variety of risks and difficulty. New methods and systems for creating new markets for collectibles and memorabilia are desired.

### OVERVIEW

The present inventors have recognized, among other things, that a problem to be solved is the need for new and/or alternative methods and systems for creating new markets for collectibles and memorabilia. In addition, new types of collectibles and/or memorabilia would also be desirable.

This overview is intended to provide an introduction to the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates prior art memorabilia activity;

FIGS. 2-3 show illustrative examples; and

FIG. 4 shows illustrative infrastructure.

### DETAILED DESCRIPTION

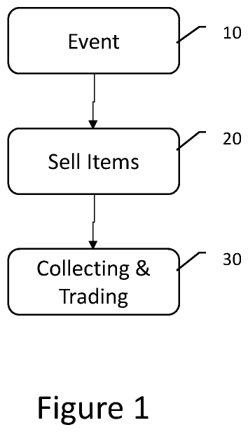

FIG. 1 illustrates prior art memorabilia activity. The typical way for sports memorabilia to arrive in the collectibles market would be for an item to be used in an event 10, such as a uniform worn by an athlete or an item used by or on a contestant such as the bridle of a horse, or a ball used in a game. The item would then be sold 20, such as via an auction or by direct sale at a list price. An important element in the prior art is the need to authenticate the item from the event 10 for its sale 20. After the initial sale, further collecting and trading can take place 30 among dealers and private collectors.

A separate form of collectibles, aside from memorabilia, is the use of trading cards, such as baseball cards. There, the trading card is created specific to a particular athlete without specific reference to an upcoming event. In general trading cards are generated on an annual basis, such as with baseball cards where a new set of cards can be created at the start of each season.

Memorabilia and collectibles, in the context of the present invention, may involve, be used in, or capture information, data, images, etc. related to a wide variety of events, including, for example and without limitation, a tennis match or tournament, a soccer match, a football game, a baseball game, a basketball game or tournament, a track and field event, a swimming event, any Olympic event, a combat event, a golf match, a hockey game, an equestrian event, a fishing tournament, a shooting competition, and/or an esports event.

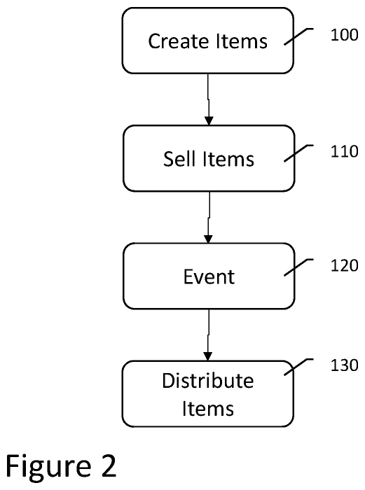

FIG. 2 shows an illustrative example. Here, the collectible item is created or identified in advance, as indicated at 100, and then sold in advance as shown at 110. Sale in advance may include offering the item for sale ahead of the event. For example, items may be sold or offered for sale at a fixed price or via auction. In some examples, an auction sale may be used that starts before the event, but concludes during or at the start of the event, if desired.

The event then takes place, as indicated at 120, and the pre-sold items are distributed as indicated at 130. In this example, the created items 100 may be specific to a particular event, such as a race or game, and are then worn or used, for example, in the event 120, prior to distribution. This methodology allows the buyer from step 110 to feel a greater association with the event 120, but also generates excitement associated with the potential for the pre-purchased item to increase in value during the event 120. For example, if the pre-sold item is a jersey, the jersey is likely to increase in value if the athlete wearing the jersey has a great performance during the event, for example by winning the event, placing in a race, scoring points or runs, or otherwise achieving something during the event.

In some examples the item created at 100 is standard equipment for use in the event to which a marker may or may not be applied. For example, the item 100 may be a jersey, shoes, helmet, glove, pad, other apparel or protective gear, ball, stick, tee, racquet, club, steering wheel, saddle, bridle, wheel, or any other object used during a sporting or other event. A marker may be applied, if desired, such as an indelible marking, or attachment of an electronic identifier such an RFID tag.

Of note in this regard is that the item created at 100 may or may not be standard equipment for use in the event 120. For example, the athlete may have a patch attached to a jersey or piece of equipment (padding, helmet, glove), which may or may not be visible during action. The patch may itself carry an RFID or other digital tag, feature or device, if desired. The inclusion of a digital feature such as an embedded chip may be useful for later authentication, whether at the initial sale or in the context of product resale or trading. A patch or other device may, in some examples, have upgradeable or read/writeable memory thereon, or added thereto after the event, on which information about the athlete's performance and/or the event may be added. Rather than a patch, a card may be used. To add aesthetic value the patch, card, tag or other device may be made with a metal layer, carbon fiber, or other unique structure to provide enhanced weight and appearance. An image may be provided that can be associated with one or more of the athlete, event or team, as desired. In still another example, an RFID tag in the form of a thread (such as that of EON-ID Group) may be integrated into a sporting good item, such as a uniform or other apparel, a ball, bat, racket, helmet, etc., to aid in authentication. While current iterations of some such threads are not themselves programmable, in some examples, a plurality of RFID threads may be applied in unique combinations to a sporting good item, allowing numbering and other specific characteristics to be provided/applied to the item.

In another example, a wearable device may be provided to an athlete (a person or animal, depending on the event), or to a garment or piece of equipment worn by the athlete, and may comprise a data recording feature or element, such as a wearable tracker that records motion, acceleration, speed and/or various biometrics (pulse rate, sweat generation, temperature). For example, wearable recording apparatuses for use in athletic performance are known and commercially available from Catapult Sports and/or Alogo.io, as well as various consumer fitness trackers (Apple Watch, Fitbit, Garmin, and others make wearables that track motion and other parameters or features) and such apparatuses may be used as the created item. Such products may incorporate temperature sensors, accelerometer(s) to record motion, light emitting and recording systems using pulse oximetry or other methods to capture pulse rate, blood oxygenation, etc. and/or global positioning system (GPS) circuitry, etc., to allow various data to be recorded. A wearable device may also be used to capture video and/or audio data, if desired. In some examples, rather than the worn recording apparatus, one or more memory cards may be the created items to which data from a wearable recording apparatus is written. Such memory cards may be packaged with a tangible product as well, such as a jersey, or may be sold separately. To add to the desirability and exclusiveness, the quantity of items made available can be limited. A vehicle, such as a car, boat, motorcycle, snowmobile, bobsled, etc. may instead carry a recording apparatus to capture data during an event.

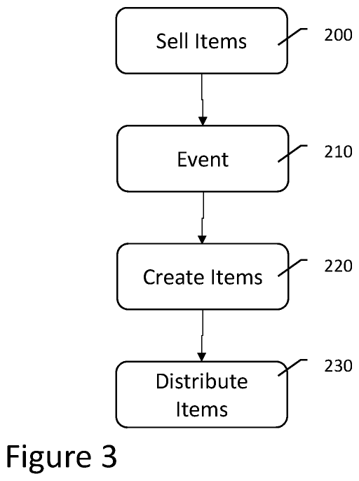

In still further examples, the “item” may not be tangible and may instead take the form of a digital card or collectible, recorded on a non-transitory medium. A digital card may be assembled after an event, as shown in FIG. 3. Here, the item may be pre-sold at 200, and an event takes place at 210. The digital collectible can then be created at 220, and may include data recorded by a wearable recording apparatus. Such an item can then be distributed at 230. The use of a digital card, or a digital recording element as in the preceding example, can make authentication simpler by incorporating digital security such as Blockchain transaction encoding and/or public/private key technology. It should be understood that in some examples, the physical, tangible object is pre-sold and distributed, such as by selling a product that incorporates a memory in it. In other examples, no tangible physical object is distributed and, instead, the digital collectible items is sold in the online sense, such as via a Blockchain technology, for example. In still other examples, the collectible includes both digital elements and tangible elements, where the digital elements are not necessarily stored by or on the tangible element.

An example of a digital card or digital collectible item may include a non-fungible token (NFT). An NFT is a data unit that can be stored via Blockchain, and may be sold and/or traded. An NFT can be associated, for example and without limitation, with a data file such as a video or audio recording, data captured and/or stored using a wearable device, a photograph, and any other data described above. In addition, an NFT may be associated with a physical object as well, allowing, for example, a combination to be sold or traded such as an NFT relating to an object (a piece of sporting equipment, for example and without limitation) as well as a stored video recording. For example, an NFT may be associated with a baseball as well as a video of that same baseball being used in a game. In a further example, baseballs used in games that have the potential to become valuable collectibles can be marked to number them, as for example happens during World Series games and/or when a player approaches a milestone. Thus, a collectible item may include each of a video and a ball which can be associated together via a token such as an NFT.

Some examples may include the creation of a limited quantity of digital cards or digital collectible items, wherein at the time of creation each such digital collectible item is identical except for a unique identifier. That is, the stored data may be the same for each of the limited quantity, although each remains non-fungible insofar as each carries a unique identifier. In other examples, each of the limited quantity has overlapping data, but is unique in some respect, whether by allowing the initial purchaser to personalize or customize the digital collectible, or by intentionally selecting different elements to include, such as by using a different stored digital video, interview, etc. for each of the limited quantity.

While some examples focus on an athlete and a specific event, other examples may include, for example, and without limitation, non-athlete items. For example, an NFT can be pre-sold before an event (via auction or fixed price sale, or other suitable approach) which is associated with a performance associated with the event, such as a song (National Anthem) or other performance (halftime show), or an action by a mascot, such as the entrance or a celebration performed by the mascot. An “event”, moreover, may include a string of related events, such as the Tour de France or a golf, basketball or other tournament, or a sporting season (a baseball season, a tennis tour season, etc.).

In some examples, with a digital collectible item, a central server may be used to allow the user to engage in an interactive or exclusive experience. For example, recorded data can be correlated to event highlights, providing an “insider” experience as the user can access highlights, data, athlete commentary once authenticated. In some examples, only the current owner of the tradeable collectible item can access the “insider” experience. The central server may also be used for authentication purposes.

If using, for example, Blockchain (such as, for example and without limitation to a single form, Ethereum, which has been used to support NFTs), to create a digital collectible, a record of the history of the collectible can be carried in the data associated with the digital collectible, as desired. In addition, as currently implemented, some platforms that may be usable to create a digital collectible may include file size or type limitations. If so, a server or repository may store portions of the digital collectible. In some examples, the digital and/or physical collectible item may be accessible during the event by a user to allow the user to observe recorded features. For example, if a wearable device captures biometric and/or motion data, or other data, during the event, such data may be communicated (such as by wireless communication using any of WiFi and/or Bluetooth, or other communication mode) to a central server during and/or after the event. The owner of the collectible item may be provided with an access code to use during the event to access and observe recorded data, whether in real-time or in near-real time, as desired. For example, an owner of the digital collectible may be provided the opportunity to engage in a virtual reality (VR) experience, such as by wearing a VR device to observe video and/or audio captured during the event, as the event is ongoing.

In some examples, the collectible item may be tailored to the particular owner, who may select data to be captured and associated with the digital collectible item. In some examples, the owner may be allowed to combine the collectible item generated in association with the event with their own additional content, such as an image or recording of the owner watching, preparing for, or celebrating the event. In this way, the collectible item also becomes an heirloom, personal to the owner.

In an example, a digital collectible item, or hybrid physical-digital collectible item, may be one that updates over time. For example, a person interested in horse racing may purchase a collectible item associated with a particular horse at the start of the horse's racing career. The digital collectible item may be updated over time to associate the collectible with multiple highlights, or recorded data, etc., as described above, throughout the horse's career. In other examples, the digital collectible may be linked to an athlete in any sport, and may be updated with highlights or recorded data, etc., as described above, throughout the career of the athlete.

While much of the above is focused on sports and competition, any notable event may serve as the basis for generating a tradeable collectible item. For example, the first manned mission to Mars could serve as the basis for generating a collectible item, comprising, for example, recorded data during the launch, voyage, landing, and/or return associated with such a mission. A presidential inauguration, election, or campaign, may be another example.

U.S. Pat. No. 8,706,591 provides examples of infrastructure that may be used to arrange for pre-sale of an interest in an event such as an athletic or sporting contest. Similar infrastructure may be used in the present invention for pre-event sale of items. Other infrastructures, such as those known for EBAY® and/or other online (or not-online) auctions may be used instead, as desired.

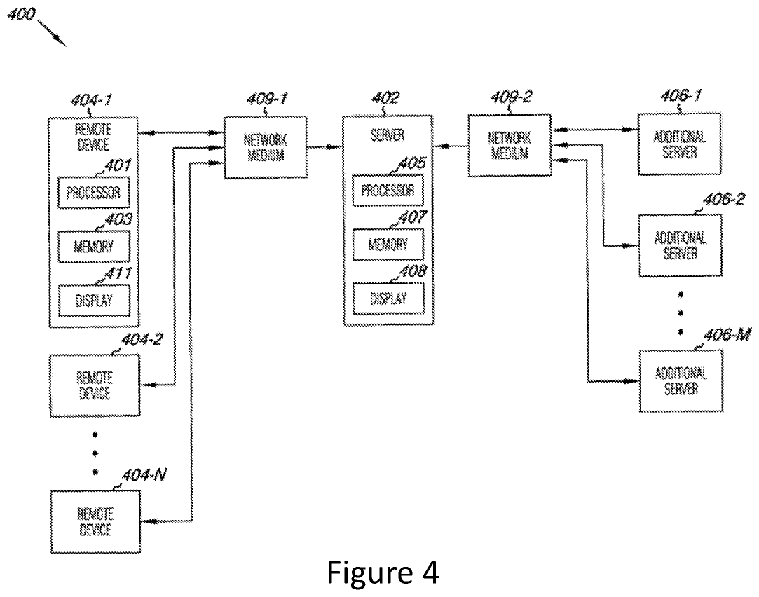

FIG. 4 illustrates an embodiment for electronic devices and computer readable medium in a computing device network 400. The electronic devices and computer readable medium in the computing device network 400 can electronically perform the methods described herein. The embodiment of FIG. 4 illustrates a network 400 that includes an electronic computing device, which may take the form of a server 402. The server 402 includes a processor 405 coupled to a memory and/or database, stored, for example, on computer readable medium 407 such as a memory (RAM, ROM, Flash, or other memory structure, whether local, remote, or cloud-based). The server 402 can further include a display 408 and one or more input/output (I/O) devices (not shown) such as, for example, a mouse, keyboard, microphone, touch screen, etc. Processor 405, memory 407, and display 408 can include any type of processor, memory, and display capability in the art of computing.

As shown in the embodiment of FIG. 4, the server 402 can be connected to a number of additional electronic devices, shown as 404-1, 404-2, . . . , 404-N, such as remote computing devices. The designator “N” is intended to indicate that any number of remote devices can be connected to the server 402 over a network 400. The remote devices 404-1, 404-2, . . . , 404-N can similarly include processor 401, memory 403, and display 411 capabilities, as well as I/O devices. The server 402 and/or remote devices 404-1, 404-2, . . . , 404-N are capable of including program instructions/software (e.g., computer executable instructions) to cause a server 402 or other devices 404-1, 404-2, . . . , 404-N to perform particular functions, such as the methods described herein. As shown in the embodiment of FIG. 4, devices 404-1, 404-2, . . . , 404-N can couple to the server 402 through a network medium 409-1. The network medium 409-1 through which the devices 404-1, 404-2, . . . , 404-N can couple to the server 402 include a number of medium types. For example, the network medium 409-1 can include a local area network (LAN), e.g. an Ethernet network, a wide area network (WAN), a wireless local area network (WLAN), the public switched telephone network (PSTN), and/or the Internet using transmission control protocol/Internet protocol (TCP/IP). Embodiments of the invention are not so limited to these examples and can include combinations of these networks connecting through gateways, hubs, switches, routers, service switching points (SSPs), service control point (SCP) databases, signal transfer points (STPs), mobile switching centers (MSCs), and the like as the same are known and understood by one of ordinary skill in the art. Networks, as used herein, can include wireless networks as can be accessed by cell phones, smart phones, tablets, laptops, etc. Wireless networks can include Bluetooth, Global System for Mobile communications (GSM) networks and associated protocols, American National Standards Institute (ANSI) networks and associated protocols, Public Wireless Local Area Networks (PWLANs) including Wireless Fidelity (Wi-Fi) networks and associated protocols. Thus, devices described herein can be coupled in either direct hardwired fashion, e.g. using copper, coaxial cable, optical fiber connections, and hybrid fiber-coax connection, and/or indirectly in a wireless fashion.

Network 400 illustrates that the above described components can couple to additional servers and/or computing devices, 406-1, 406-2, . . . , 406-M, over a network medium 409-2 as the same has been described above. The designator “M” is intended to indicate that any number of additional servers and/or computing devices can be connected to the server 402 in a single network or combination of networks 400. Such additional servers and/or computing devices, 406-1, 406-2, . . . , 406-M, can be maintained by other organizations, or entities. The additional servers and systems, 406-1, 406-2, . . . , 406-M, can include core databases accessible by the server 402 according to definable access rights. The additional servers and systems, 406-1, 406-2, . . . , 406-M, can include databases and executable instructions or programs to operate on data, host websites, and can possess PSTN processing and routing capabilities or other network connectivity as described above. The additional servers and systems, 406-1, 406-2, . . . , 406-M, can include proprietary databases, data modules, and software systems maintained by a third party, such as a third party Internet auction site. The server 402, the number of remote devices 404-1, 404-2, . . . , 404-N, and the additional servers and systems, 406-1, 406-2, . . . , 406-M, can all include computer readable medium having computer-executable instructions stored thereon, such as in any suitable memory type as described above.

An illustrating and non-limiting example takes the form of a method of creating a collectible item comprising: applying a recording apparatus to a participant in an event; activating the recording apparatus and recording participation data as the participant engages in the event; loading the participant data from the recording apparatus; and incorporating the participant data into the collectible item.

Additionally or alternatively, incorporating the participant data into the collectible item comprises creating a non-fungible token (NFT) linked to at least a portion of the participant data, and storing the non-fungible token in a non-transitory memory. The NFT may be linked to at least a portion of the participant data by, for example, storing at least a portion of the participant data (or a copy thereof) in the NFT, or the NFT may include a pointer or key for finding and/or accessing the participant data in whole or in part from a server or other memory.

Additionally or alternatively, incorporating the participant data into the collectible item comprises storing the collectible data in a memory physically forming the collectible item.

Additionally or alternatively the collectible item is a card.

Additionally or alternatively, the participation data includes physiological data of the participant. Such physiological data may include, for example and without limitation, temperature, pulse rate, calories burned, blood pressure, etc. of the participant.

Additionally or alternatively, the participation data includes data related to the motion of the participant.

Additionally or alternatively, the participation data includes at least one of audio and video data. In examples, the recording apparatus may include a microphone and/or camera, if desired. The recording apparatus may include a transmitter or transceiver for communicating recorded data from the recording apparatus to a communication network, such that the participation data may be accessed or observed during the event itself.

Additionally or alternatively, the collectible item includes an object or piece of apparel used in the event. Objects may include, for example and without limitation, sporting equipment (bats, rackets, gloves, balls, goggles, helmet, pads, etc.) used in the vent, or may include an item controlled during the event such as a vehicle, sled, toboggan, etc.

Additionally or alternatively, the participant may be a horse or other animal active during the event.

Additionally or alternatively, the participant may be a human, and the event is one of a tennis match, a soccer match, a football game, a baseball game, a basketball game, a track and field event, a golf match, a hockey game, an equestrian event, a fishing tourney, a shooting competition, an e-sports event, or a combat event.

Additionally or alternatively, the method may include storing data related to the event along with the participant data in the collectible item, wherein the data related to the event comprises at least one of: audio, video or image from the event; statistical data related to the event; and a result of the event. The data related to the event may come from sources other than the collectible item.

Another illustrative and non-limiting example takes the form of a method of creating and selling a collectible item, comprising: in advance of an event, selling a right to receive the collectible item to a buyer; performing method of creating a collectible item comprising: applying a recording apparatus to a participant in an event; activating the recording apparatus and recording participation data as the participant engages in the event; loading the participant data from the recording apparatus; and incorporating the participant data into the collectible item; and following the event, providing the collectible item to the buyer.

Additionally or alternatively, the participant data is determined by the buyer. That is, the buyer may be allowed to pick and choose which participant data to capture during the event, or before or after the event. The buyer may also determine what additional data, such as separately recorded audio, video or other data, or statistics, results, images, etc. to be combined into the collectible item.

Additionally or alternatively, the method may further comprise during the event, allowing the buyer to access the participant data being collected during the event.

Additionally or alternatively, the step of providing the collectible item to the buyer comprises enabling access by the buyer to digital content.

Additionally or alternatively, the step of providing the collectible item to the buyer comprises physically delivering the collectible item to the buyer.

Additionally or alternatively, the step of providing the collectible item to the buyer comprises enabling access by the buyer to digital content and physically delivering the collectible item to the buyer.

Another illustrative and non-limiting example takes the form of a method of making and selling a collectible item, comprising: selling a collectible item related to an event before occurrence of the event; as or after the event occurs, creating the collectible item;

and delivering the collectible item after the event has occurred.

Additionally or alternatively, the collectible item is a physical object worn during the event by a participant in the event, the physical object including a recording apparatus configured to capture data related to the participant's physical state or actions during the event, wherein creating the collectible item comprises storing data from the recording apparatus in the physical object.

Additionally or alternatively, the collectible item is a digital collectible item comprising data related to the actions or physical state of a participant in the event during the event.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method of creating a collectible item comprising:
applying a recording apparatus to a participant in an event;
activating the recording apparatus and recording participation data as the participant engages in the event;
loading the participant data from the recording apparatus; and
incorporating the participant data into the collectible item.

2. The method of claim 1 wherein incorporating the participant data into the collectible item comprises creating a non-fungible token linked to at least a portion of the participant data, and storing the non-fungible token in a non-transitory memory.

3. The method of claim 1 wherein incorporating the participant data into the collectible item comprises storing the collectible data in a memory physically forming the collectible item.

4. The method of claim 3 wherein the collectible item is a card.

5. The method of claim 1 wherein the participation data includes physiological data of the participant.

6. The method of claim 1 wherein the participation data includes data related to the motion of the participant.

7. The method of claim 1 wherein the participation data includes at least one of audio and video data.

8. The method of claim 1 wherein the collectible item includes an object or piece of apparel used in the event.

9. The method of claim 1 wherein the participant is a horse.

10. The method of claim 1 wherein the participant is a human, and the event is one of a tennis match, a soccer match, a football game, a baseball game, a basketball game, a track and field event, a golf match, a hockey game, an equestrian event, a fishing tourney, a shooting competition, an e-sports event, or a combat event.

11. The method of claim 1 further comprising storing data related to the event along with the participant data in the collectible item, wherein the data related to the event comprises at least one of:
audio, video or image from the event;
statistical data related to the event; and
a result of the event.

12. A method of creating and selling a collectible item, comprising:
in advance of an event, selling a right to receive the collectible item to a buyer;
performing the method of claim 1 to create the collectible item; and
following the event, providing the collectible item to the buyer.

13. The method of claim 12 wherein the participant data is determined by the buyer.

14. The method of claim 12 further comprising, during the event, allowing the buyer to access the participant data being collected during the event.

15. The method of claim 12 wherein the step of providing the collectible item to the buyer comprises enabling access by the buyer to digital content.

16. The method of claim 12 wherein the step of providing the collectible item to the buyer comprises physically delivering the collectible item to the buyer.

17. The method of claim 12 wherein the step of providing the collectible item to the buyer comprises enabling access by the buyer to digital content and physically delivering the collectible item to the buyer.

18. A method of making and selling a collectible item, comprising:
selling a collectible item related to an event before occurrence of the event;
as or after the event occurs, creating the collectible item; and
delivering the collectible item after the event has occurred.

19. The method of claim 18 wherein the collectible item is a physical object worn during the event by a participant in the event, the physical object including a recording apparatus configured to capture data related to the participant's physical state or actions during the event, wherein creating the collectible item comprises storing data from the recording apparatus in the physical object.

20. The method of claim 18 wherein the collectible item is a digital collectible item comprising data related to the actions or physical state of a participant in the event during the event.
